(19) United States
(12) Patent Application Publication
(10) Pub. No.: US 2007/0271316 A1
(43) Pub. Date: Nov. 22, 2007

(54) System and method for backing up medical records

(75) Inventor: Robert J. Hollebeek, Berwyn, PA (US)

Correspondence Address: RATNERPRESTIA, P O BOX 980, VALLEY FORGE, PA, 19482-0980, US

(73) Assignee: i3Archives, Inc.

(21) Appl. No.: 11/438,641

(22) Filed: May 22, 2006

(51) Int. Cl. G06F 17/30

(52) U.S. Cl. 707/204

(57) ABSTRACT

A method of backing up medical records stored as electronic record in a system that includes a network interface device and a remote archive. The method includes routing a selected medical record to the network interface device linking the selected medical record and a backup copy thereof, stored at first and second locations, respectively, the first and second locations being remote from each other; and establishing one or more further backup copies of the selected medical record at one or more respective further backup locations, when at least one of the selected medical record or the backup copy thereof are to be removed from a respective one or ones of the first and second locations, each further backup location being remote from other further backup locations and from the first and second locations.

### FIELD OF INVENTION

The present invention relates to the field of storage and retrieval systems and, more particularly, to a method and system for backing up medical records.

### BACKGROUND OF THE INVENTION

In recent years, many different types of medical images have increasingly been digitized (e.g., x-ray images, full field mammography images and ultrasound images, among others) and these medical images are stored in a digital format. As such, hospitals are now experiencing a growing need for large storage systems to handle the large number of the medical records and images stored in these digital formats. As the number of stored medical records and images increases, storage capacity on medical networks (e.g., secured hospital networks) is becoming more prohibitive, since space to store such records and images also must increase. Moreover, disaster recovery and/or back-up storage procedures are a consideration due to the importance of the medical records and retention requirements for these records.

### SUMMARY OF THE INVENTION

The invention may be embodied as a method for backing up medical records or computer readable medium for use with a computer for storing a program to execute the method for backing up the medical records. The medical records are stored as electronic record in a system that includes a network interface device and a remote archive. The method includes routing a selected medical record to the network interface device, transferring one or more backup copies of the selected medical record to the remote archive, linking the selected medical record and the backup copies thereof, each stored at locations geographically remote from each other, and establishing one or more further backup copies of the selected medical record at one or more respective further backup locations, when at least one of the selected medical record or the backup copy thereof are to be removed from a respective one or ones of the geographically remote locations, each further backup location being remote from other further backup locations and from the geographically remote locations.

The invention may be further embodied as a method of copying medical records stored as electronic records in a system that includes geographically dispersed storage devices. The method includes routing a selected medical record to and storing the selected medical record in a first storage device at one geographical location, and automatically creating a copy of the selected medical record at another geographical location, different from the location of the selected medical record, when the selected medical record is removed from the system.

The invention may be further embodied as a system for backing up electronic medical records. The system includes a network interface device located at a first geographic location for receiving a selected medical record, the network interface device including a first linking table, first and further remote archives include second and further linking tables, respectively, and are located at second and further locations which are different in geographic location from each other and from the first geographic location such that respective ones of the network interface device and the first and further remote archives store the selected medical record and a backup copy of the selected medical record. Linking tables corresponding to the respective ones of the network interface device and the first and further remote archives store pointers to the selected medical record and the backup copy of the selected medical record such that when at least one of the selected medical record or the backup copy thereof are to be removed from a respective one or ones of the first and second locations, one or more further backup copies are automatically stored in other ones of the network interface device and the first and further remote archives different than the respective ones of the network interface device and the first and further remote archives.

### BRIEF DESCRIPTION OF THE DRAWINGS

The invention is best understood from the following detailed description when read in connection with the accompanying drawings. It is emphasized that according to common practice the various features/elements of the drawings may not be drawn to scale. On the contrary, the dimensions of various features/elements may be arbitrarily expanded or reduced for clarity. Moreover, in the drawings, common numerical references are used to represent like features/elements. Included in the drawings are the following figures:

FIG. 1 is a schematic diagram illustrating a generalized storage and retrieval system in accordance with an exemplary embodiment of the present invention;

FIG. 2 is a schematic diagram illustrating a storage and retrieval system in accordance with another exemplary embodiment of the present invention;

FIG. 3 is a flow chart illustrating a method of backing up medical records in accordance with yet another exemplary embodiment of the present invention;

FIG. 4 is a flow chart illustrating a method of backing up medical records in accordance with yet another exemplary embodiment of the present invention;

FIG. 5 is a flow chart illustrating a method of backing up medical records in accordance with yet another exemplary embodiment of the present invention; and

FIG. 6 is a schematic diagram illustrating a distribution method of copying/backing up medical records in accordance with certain exemplary embodiments of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims without departing from the invention.

Although the present invention is described in terms of a storage and retrieval system for backing up medical records, the present invention may be applied to other types of network systems and information, for example, networks with financial and legal information, among others. It is contemplated that exemplary embodiments of the present invention may be applicable generally to backup or disaster recovery functionality/services that may be supplied though a secured network interface from one or more remote archives.

Although the present invention is described in terms of an external (remote) archive for storing medical records, a network interface device and a plurality of end-user devices, it is contemplated that exemplary embodiments of the present invention are not limited to a single network interface device, or a single external (remote) archive but instead selected records may be backed up in any number of remote archives via any number of network interface devices.

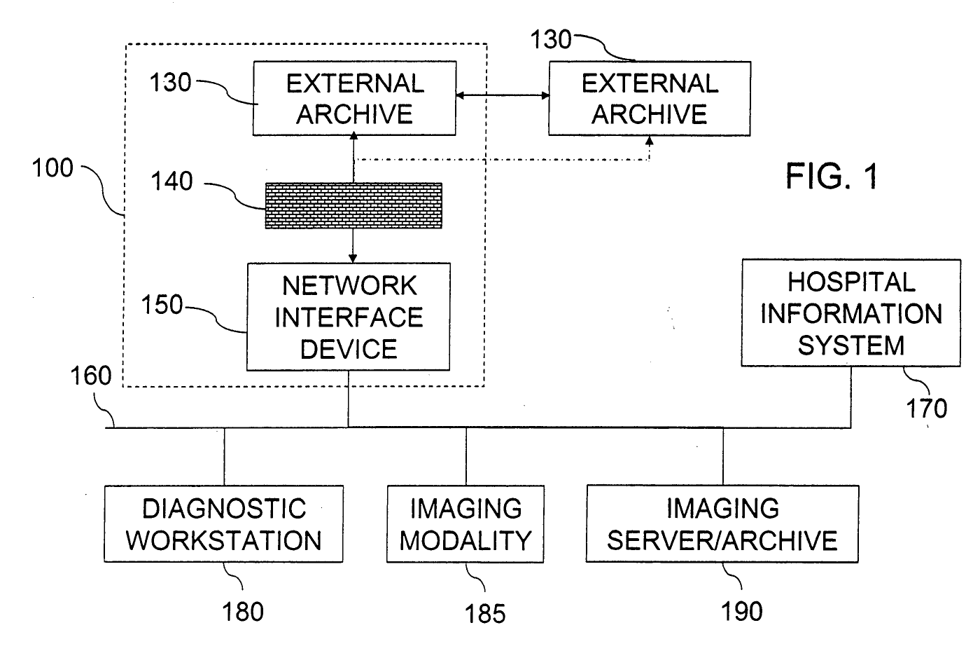

FIG. 1 is a schematic diagram illustrating a storage and retrieval system 100 in accordance with an exemplary embodiment of the present invention.

Referring now to FIG. 1, storage and retrieval system 100 is configured to work with a secured network 160 (e.g., a secured medical network) and includes an external (e.g., remote) archive 130, a firewall 140 and a network interface device 150. Firewall 140 prevents unauthorized users from accessing secured network elements 170, 180, 185 and 190 and network interface device 150 which are coupled to secured network 160. External archive 130 may include storage for storing medical records in digital format, for example (medical images (e.g., x-ray images, mammography images, other radiological images and ultrasound images, among others), patient histories, physician reports, computer-generated medical reports, patient information and/or patent studies. External archive 130 may communicate via firewall 140 and network interface device 150 to secured network 160.

Secured network 160 may include any number of secured network resources, for example: (1) a hospital information system 170 which manages hospital information records such as patients appointments, medical procedure schedules and medical resource availability, among others; (2) one or more diagnostic workstations 180 that are used by medical personnel (e.g., end-users) for review and diagnosis of patient studies and/or selected medical images, among others; (3) one or more imaging modalities 185 for generating the patient studies/selected medical images/records; and (4) one or more imaging servers/archives 190 for storing patient studies/selected medical records either temporarily or permanently based on storage rules.

Diagnostic workstations 180 refer to computer workstations used by a medical personnel (e.g., radiologists, medical technicians, and others) to perform diagnosis by referencing selected images, patent records, computer generated medical report and/or patent histories, among other. These diagnostic workstations are typically capable of image processing to enhance images and to compare sets of images (patient studies) for medical diagnosis of a patient's condition and may produce, for example, computer generated medical reports.

Imaging modalities 185 refer to systems for imaging of a patent, for example computed tomography (CT) scan, Magnetic Resonance Imaging (MRI), Positron Emission Topography (PET) scan, Ultrasound Imaging, and X-ray Imaging, among others. Digital images may be produced directly from the imaging process or, otherwise, a film of an image may be scanned into a digital format and stored in a file.

Hospital information system 170 refers to any system used on a hospital medical network that provides information for use in determining selection of medical records to be stored or backed up on the external archive, and/or in imaging server archive of network interface device 150.

Secured network 160 may operate using one or more network protocols/standards, for example, in secured medical network 160, the standard may be Digital Imaging in Communications in Medicine (DICOM) and/or Hospital Level 7 (HL7). Network interface device 150 may provide protocol conversion from the protocols/standards used on secured network 160 to/from a protocol (for example, an NDMA or GRID protocol, among others) for bi-directional communication to/from external archive 130.

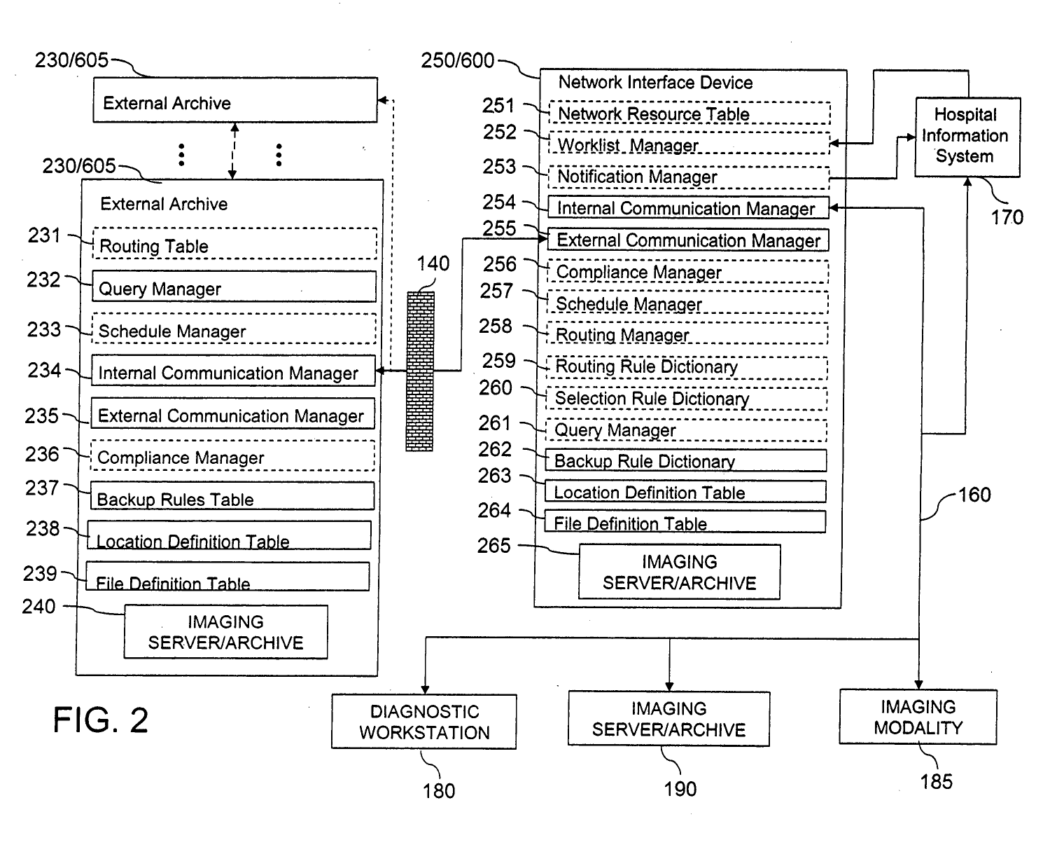

FIG. 2 is a schematic diagram illustrating a storage and retrieval system for retrieving medical images in accordance with another exemplary embodiment of the present invention.

Now referring to FIG. 2, the storage and retrieval system may include one or more external archives 230, firewall 140 and a network interface device 250 and may be configured to work with secured network 160. Secured network 160 may include: (1) hospital information system 170; (2) end-user devices such as one or more diagnostic workstations 180 and/or one or more imaging modalities 185; and (3) one or more image servers/archives 190.

In certain exemplary embodiments, network interface device 250 may include: (1) a network resources table 251; (2) a worklist manager 252; (3) a notification manager 253; (4) an internal communication manager 254; (5) an external communication manager 255; (6) a compliance manager 256; (7) a schedule manager 257; (8) a routing manager 258; (9) a routing rule dictionary 259; (10) a selection rule dictionary 260; (11) a query manager 261; (12) a backup rule dictionary 262; (13) a location definition table 263; (14) a file definition table 264; and (15) an imaging server/archive 265.

Network resource table 251 may include a table that defines network addresses for each end-user device 180 and 185 having medical records routed thereto or therefrom and IP addresses of remote archives 230 external to the secured medical network 160. Worklist manager 252 of network interface device 250 may receive a worklist from hospital information system 170. Worklist manager 252 may also determine a selection criteria for selecting medical records from secured network resources, 180 185 and 190 according to back-up rules stored in back-up rule dictionary 262.

Notification manager 253 may provide a notification to hospital information system 170 as to whether a particular record which is selected for storage or backup by worklist manager 252 has been stored in or provided to network interface device 250 from secured network resources 180, 185 and 190 and whether the storage or backup process is complete and may generate a report of the location or locations of the particular medical record and any backup copies thereof. The notification may be a status report regarding the selected medical record and/or may be an exception report which indicates errors/compliance issues which prevented certain selected medical records from being stored and/or backed up in accordance with preset (e.g., user settable) backup rules stored in backup rule dictionary 262.

Internal communication manager 254 may manage communication from network interface device 250 to respective network resources (for example, resources 180, 185 and 190) and hospital information system 170 based on protocols/standards of secured network 160. External communication manager 255 may manage communication between network interface device 250 and external communication manager 235 of one or more external archives 230. External communication managers 235 and 255 are desirably configurable to allow communication via firewall 140. That is, external communication managers 235 and 255 may allow reconfiguration of protocols and ports to enable communication through firewall 140 between network interface device 250 and respective external archives 230.

Compliance manager 256 may determine whether medical records which are stored and/or backed up on the network interface device 250 and/or one or more external archives 230 are in compliance with, for example, Health Insurance Portability & Accountability Act (HIPAA) compliance requirements or other archive policies or procedures. If the information in the worklist from the hospital is not in compliance with HIPAA compliance requirements or the other archive policies or procedures, compliance manager 256 directs notification manager 253 to notify hospital information system 170 in a notification or status report (e.g., an exception report) that specific requirements for storage and/or backup of selected medical records are not in compliance with particular HIPAA compliance requirements and/or the other archive policies or procedures.

Schedule manager 257 may manage scheduling of internal and external communications from/to network interface device 250 by internal communication manager 254 and external communication manager 255 based on timing requirements. Such timing requirements may be determined according to priority level of a particular medical record, the type of medical record, and available capacity of storage devices, for example, imaging servers/archives 265 and 190, among others and/or other established scheduling rules.

Routing manager 258 may manage routing of selected medical records between network resources (e.g., diagnostic workstations 180, imaging servers/archives 190 and imaging modalities 185) network interface device 250 and remote archive 230 based on routing rules stored in routing rule dictionary 259. Routing rule dictionary 259 may include reconfigurable routing rules.

For example, routing rule dictionary 259 may include an out-of-service list which indicates system or network resources that are not available or are not available at specifically identified times. For example, based on scheduling set forth by schedule manager 257, routing manager 258 may determine that specific resources (i.e., certain remote archives 230) are unavailable based on the out-of-service list in routing rule dictionary 259, and may redirect selected medical records to other system resources.

Routing manager 258 may determine routing of selected medical records to system resources according to, for example, IP addresses of the system resources in network resource table 251, and the worklist received from hospital information system 170 via worklist manager 252. The worklist may identify certain information such as the medical record to be stored and/or backed up, the age of the medical record, the type of the medical record, and the priority of the medical record, among others. This may be used in conjunction with various routing rules to route the selected medical records or a copy thereof, for example, to a particular external archive 230.

Internal communication manager 254 of network interface device 250 may receive a medical record (i.e., a medical image, a patient study, a computer generated medical report, and/or a physician report, among others) to be stored or backed up on a system resource (i.e., the network interface device 250 or one or more external archives 230). Routing manager 258 may determine routing of this medical record according to routing and backup rules stored in backup rule dictionaries 259 and 262. The backup rules may be based on one or more criteria including, for example, (1) the available storage capacity locally and/or remotely (i.e., within the secured network or within one or more remote archives), (2) the available storage capacity of imaging server/archive 265, (3) the type of medical record received (i.e., a mammography image, a CAT scan of a certain body part, e.g., a brain scan, an ultrasound of a fetus), and (4) a priority level set by medical personal, among others. The backup rules may specify, for example, that one or more backup copies of the medical record are stored at geographically dispersed (remote) locations to ensure the availability of a copy of the medical record even in the event of a disaster or of certain equipment failures. Moreover, the backup rules may further specify additional links (pointers) to be added to various file definition tables 239 and 264 at other geographic locations to improve response time for finding a respective medical record in the system. That is, file definition table 264 stores pointers corresponding to the medical records and remote copies thereof along with information identifying the particular medical record such as, for example, a unique ID associated with only that medical record or that patient ID. Location definition table 263 establishes the geographic location of each system resource (e.g., system devices for each remote archive 230 and network interface device 250) to ensure that copies are kept geographically remote from each other.

Based on the backup rules specified in backup rule dictionary 262, internal and external communications managers 254 and 255 may transmit a copy of the selected medical record to one or more external archives 230 or to a network resource 180, 185 and 190. Backup rules may be selected from a list of backup profiles which set the backup priority level according to preset algorithms which adapt to changing system conditions, such as changes to the out-of-service list of the routing rule dictionary 259, changes in available storage capacity of the network interface device 250 or one or more external archives 230, among others.

The backup rules in back up rule dictionary 262 may be generalized and apply to each secured network 160 which is connected to one or more external archives 230 or, otherwise, may be different for each secured network such that each secured network may have a different set of backup rules stored in the respective backup rule dictionary.

Query manager 261 may manage generation of queries based on information (e.g., selection criteria) provided by worklist manager 252 of network interface device 250. That is, a query may be generated based on selection criteria from worklist manager 252 that is communicated to network resources 180, 185 and 190 via internal communication managers 234. For example, network interface device 250 may provide record selection criteria based on selection rules stored in selection rule dictionary 260 to network resources 180, 185 and 190 and may request medical reports matching the selection criteria to be returned to network interface device 250 so that network interface device 250 may route the returned medical reports to respective one or ones of external archives 230.

Each external archive 230 may include: (1) a routing table 231; (2) a query manager 232; (3) a schedule manager 233; (4) an internal communication manager 234; (5) an external communication manager 235; (6) a compliance manager 236; (7) a backup rule dictionary 237; (8) a location definition table 238; (9) a file definition table 239; and (10) an imaging server/archive 240.

Each external archive 230 may include routing table 231 to route selected medical reports to: (1) a particular medical network 160 via network interface device 250 or (2) a particular remote archive 230. It is also contemplated that external archive 230 may receive, via external communication manager 235 an address, for example an IP address, from network interface device 250 to route particular medical records.

Query manager 232 may manage generation of queries based on information (e.g., selection criteria) provided by network interface device 250. That is, a query may be generated based on selection criteria to retrieve selected medical records from imaging server/archive 240 of external archive 230

Schedule manager 233 of external archive 230 is similar to that of schedule manager 257 and controls timing of internal communication manager 234 and external communication manager 235 of external archive 230. Internal and external communication managers 234 and 235 of external archive 230 are similar to those of internal communication manager 254 and 255, respectively, and control internal communication inside external archive 230 via a first protocol/standard of external archive 230 and external communication between external communication managers 235 and 255 via an second protocol/standard, different from the internal protocol inside secured network 160.

Compliance manager 236 assures compliance with both archive policies and procedures and HIPAA requirements for external archive 230. For example, retrieval requests from an unauthorized secured network 160 (i.e., one that is not authorized to operate with external archive 230 may be stopped without further processing, or retrieval requests from an authorized secured network 160 may be stopped without further processing, if the particular hospital is not approved for retrieval of the selected medical reports/images. That is, compliance manager 236 may determine whether a valid request is being processed from an authorized secured network 160 based on information in the worklist and selection criteria from worklist manager 252 of network interface device 250.

Backup rule dictionary 237, location definition table 238 and a file definition table 239 are similar in function to that of backup rule dictionary 262, location definition table 263 and file definition table 264 of network interface device 250 but are collocated and function with their respective external archive 230.

Although only one secured network 160 with one network interface device 250 is illustrated, it is contemplated that any number of secured networks are possible and each of these secured networks may have any number of network interface devices 250 to route/interface between a respective secured network and any number of external archives 230. Network interface device 250 may route/interface with one external archive 230 with a plurality of external archives 230 interfacing with each other and/or network interface device 250 may route/interface directly with a plurality of external archives 230 to provide backup functionality among the plurality of external archives 230.

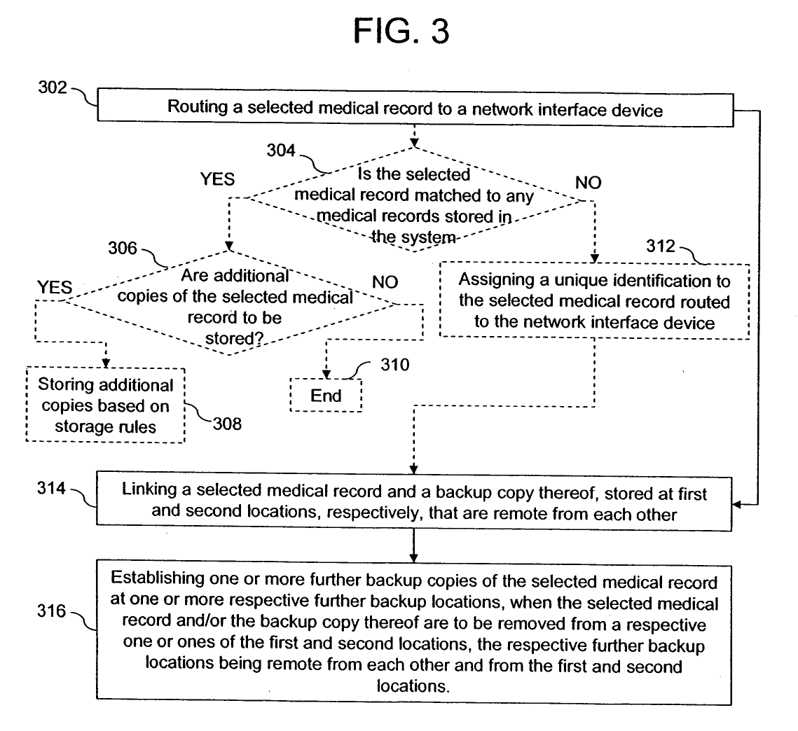

FIG. 3 is a flow chart illustrating a method of backing up medical records in accordance with yet another exemplary embodiment of the present invention.

Now referring to FIG. 3, at block 302, a selected medical record to be stored or backed up may be routed to the network interface device 250 from, for example, hospital information system 170 or an end-user device such as diagnostic workstation 180 or imaging server/archive 190, and may be received by network interface device 250.

At block 304, it may be determined whether the selected medical record matches any record stored in the system (e.g., records stored in network interface 250 and one or more respective remote archives 230). At block 306, if the selected medical record matches a record or records stored in the system, it may be determined whether additional copies of the medical record are to be stored on the system. If so, at block 308, one or more additional copies are stored on the system. This determination and storage of the additional copies may be based on the backup/storage rules in backup rule dictionary 262. At block 310, if additional copies are not to be stored on the system, processing may end.

At block 312, if the selected medical record does not match records stored in the system, a unique identification may be assigned to the selected medical record routed to network interface device 250.

In certain exemplary embodiments, this unique identification may be embedded in the medical record (i.e., the electronic file) at one or more locations which do not effect image quality associated with the medical record, and/or may be included in an XML header of the medical record.

In certain exemplary embodiments, in accordance with storage/backup rules, for example, the storage and/or backup of medical records may be based on established priorities. These priorities may be established as medical record profiles (i.e., a combination of characteristics of the medical record that establish a priority (importance) level for the medical record. For example, the priority level may be set according to one or more of the following weighted criteria: (1) a patient associated with a record may be established to have a certain priority level, e.g., based on the health of the patient; (2) the images associated with the medical record may be establish to have a certain priority level, e.g., based on the type of image and/or modality involved such as a CAT scan of a brain, an X-ray of a broken bone or a ultrasound of a fetus, among others; (3) the next estimated time of use of the medical record; and (4) the available storage on a particular storage device for normally storing the medical record, among others.

At block 314, the selected medical record and a backup copy thereof, are linked, after being stored at first and second locations, respectively, that are remote from each other. According to exemplary embodiments of the present invention, location definition table 263 may correspond network resources of the system to geographic locations to establish the geographic locations of primary and backup copies of medical records to store backup copies of the medical records at geographically remote location.

At block 316, one or more further backup copies of the selected medical record are established at one or more respective further backup locations, when the selected medical record and/or the backup copy thereof are to be removed from a respective one or ones of the first and second locations, the respective further backup locations being remote from each other and from the first and second locations.

That is, for example, pointers to the selected medical record and each backup copy may be stored in each respective file definition table 264 and 239 of network interface device 250 and remote archives 230. The pointers in the file definition tables 264 and 239 associating the selected medical record stored in network interface device 250 and the respective backup copy or back copies of the selected medical record are stored with each other.

In certain exemplary embodiments, a unique identification is stored with these pointers in file definition tables 264 and 239 at the geographic locations where the original medical record and one or more backup copies are stored. Characteristics that are distinctive to the selected medical record may be stored with the pointers in these file definition tables 264 and 239 and used as other searchable characteristics of the selected medical record, for example, in Boolean searches.

For example, (i) a patient ID; (ii) a modality; (iii) a modality station ID; (iv) a date of creation of the selected medical record; (v) a physician ID; (vi) a byte length of the selected medical record; (vii) patent name; (viii) patent birth date and/or (ix) one or more settings of the modality station may be stored with these pointers to allow for Boolean searches of the medical records in the system.

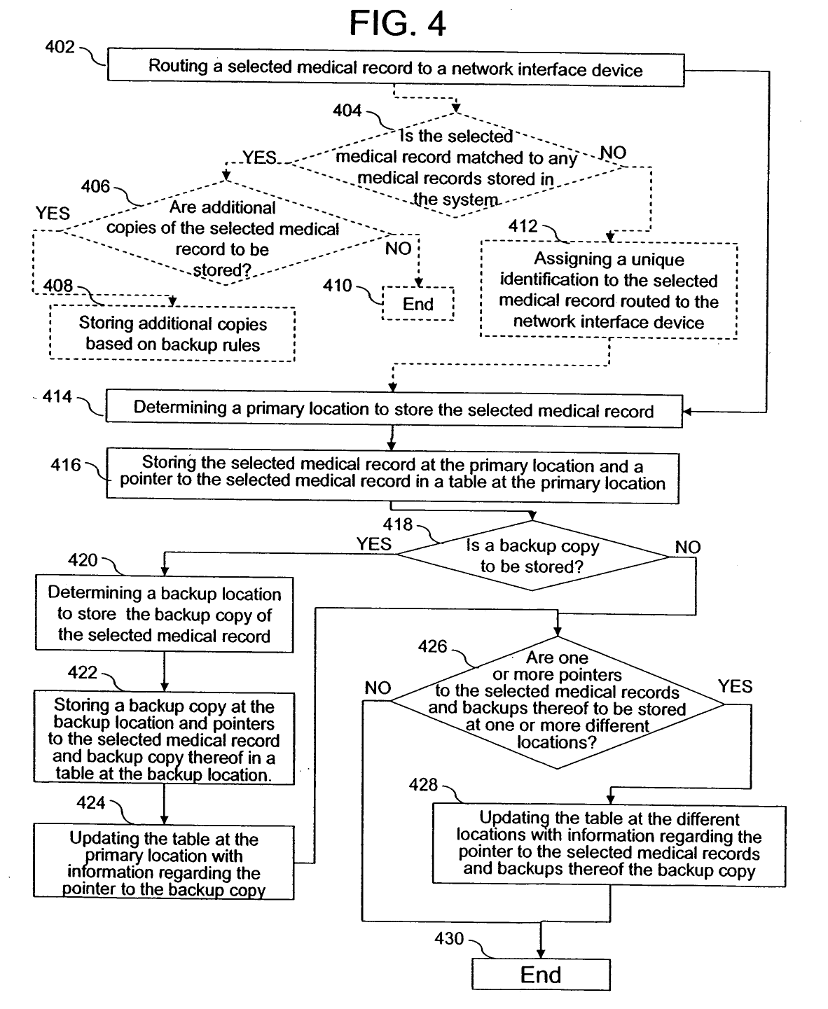

FIG. 4 is a flow chart illustrating a method of backing up medical records in accordance with yet another exemplary embodiment of the present invention.

Now referring to FIG. 4, at block 402, the selected medical record to be stored or backed up may be routed to the network interface device 250 from, for example, hospital information system 170 or an end-user device such as diagnostic workstation 180 or imaging server/archive 190, and may be received by network interface device 250.

At block 404, it may be determined whether the selected medical record matches any record stored in the system (e.g., records stored in network interface 250 and one or more respective remote archives 230). In certain embodiments, such matching may be based on characteristics of the medical record. At block 406, if the selected medical record matches a record or records stored in the system, it may be determined whether additional copies are to be stored on the system. If so, at block 408 one or more additional copies are stored on the system. This determination and storage of the additional copies may be based on the backup/storage rules in backup rule dictionary 262. At block 410, if additional copies of the medical record are not to be stored on the system, processing may end.

At block 412, if the selected medical record does not match records stored in the system, a unique identification and/or characteristic of the medical record may be assigned to uniquely identify the selected medical record routed to network interface device 250. At block 414, a primary location to store the selected medical record may be determined according to location definition table 263 in network interface device 250. At block 416, the selected medical record may be stored at the primary location which is determined according to rules (information) stored in location definition table 263 and a pointer that provides the memory location to the selected medical record may be stored in file definition table 239 or 264 located at the primary location.

At block 418, it may be determined whether one or more backup copies of the selected medical records are to be stored in the system. At block 420, if one or more backup copies of the selected medical records are to be stored in the system, one or more backup locations to store the respective backup copies of the selected medical record may be determined. The number of backup copies may be based on the backup rules in backup rule dictionary 262 and the location of the backup copies to be stored may be based on location rules in location definition table 263. At block 422, the selected medical record and each backup copy may be stored in network interface device 250 and/or one or more remote archives 230. Further, pointers to the selected medical record and each backup copy may also be stored in each respective file definition table 264 and 239 of network interface device 250 and each corresponding remote archive 230. The pointers in the file definition tables 239 and 264 associating the selected medical record stored in network interface device 250 and the respective backup copy of the selected medical record are stored with each other.

At block 424, file definition table 264 at the primary location may be updated with information regarding the pointer to a respective backup copy of the selected medical record. Block 424 may further include updating the file definition tables 239 at each respective location where a backup copy is stored using the information received by the file definition table 264, when the number of backup copies, for example, is greater than 2.

At block 426, it is determined whether or not one or more pointers to the selected medical record or stored/backed up copies thereof are to be stored at further locations based on backup and location rules. If so, at block 428, the one or more pointers to the selected medical record and stored/backed up copies thereof are stored in further file definition tables remote from the previously stored pointers to these records. That is, respective file definition tables 239 and 264 at selected locations are updated, for example, to reduce the time to locate various medical records. At block 430, processing ends for the selected medical record.

The pointers in the file definition table 264 may associate the selected medical record and each backup copy of the selected medical image with each other based on a unique identification stored with these pointers in file definition table 264. Moreover, certain characteristics of the selected medical report may be stored in the file definition table with the unique identification for conducting Boolean searches for the selected medical records based on these searchable characteristics.

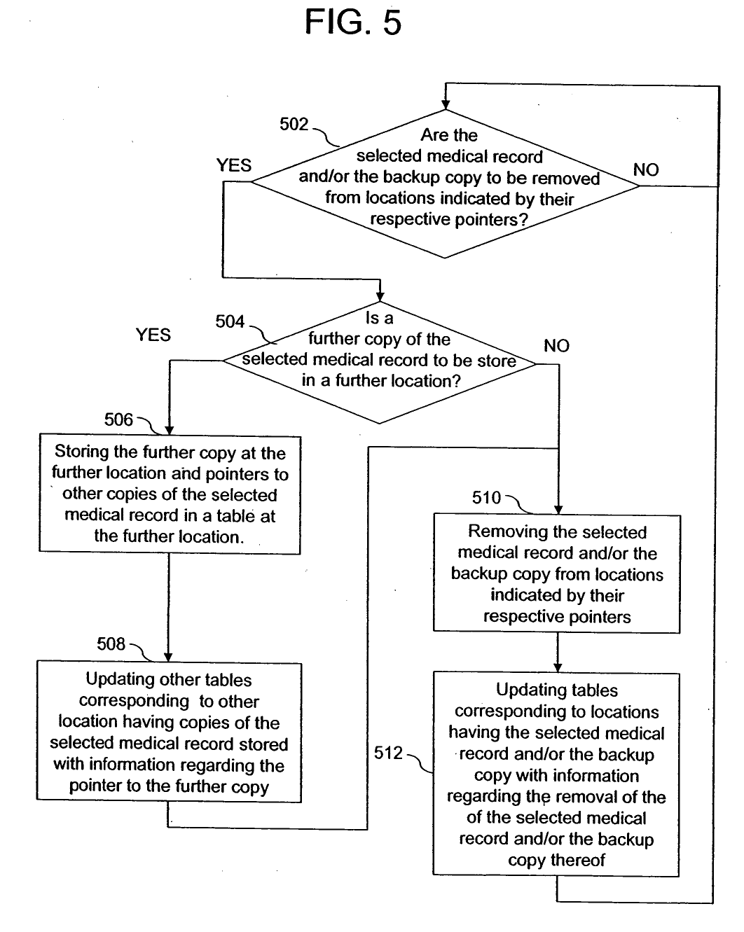

FIG. 5 is a flow chart illustrating a method of backing up medical records in accordance with yet another exemplary embodiment of the present invention.

Now referring to FIG. 5, at block 502, it may be determined whether a medical record and/or a backup copy thereof are be removed from locations on the system (i.e., the location being indicated by their respective pointers in file definition tables 264 and 239). If not, processing waits for an affirmative determination. If the medical record and/or a backup copy thereof are be removed from locations on the system, at block 504, it may be determined whether a further copy or copies of the medical record are to be stored in a further location or locations (which may be geographically dispersed from each other) based on backup rules in backup rule dictionary 262. If so, at block 506, the further copy or copies are stored at the further location or locations determined based on location rules in location definition table 263 or 238. Moreover, pointers to other copies of the medical record are stored in file definition table 239 at the selected further location or locations.

At block 508, other file definition tables 239 which corresponding to other locations having a copy or copies of the medical record are updated with information regarding the pointer or pointers to the further copy or copies of the medical record. That is, notification is sent by the remote archive or archives receiving and storing the further copy or copies to any other location having previously stored copies to update pointers regarding the medical record. In certain embodiments, other locations may also store pointer information in additional file definition tables 239 without storing copies of the medical record.

After the updating at block 508 or if no further copies are to be stored according to the determination at block 504, processing continues at block 510. At block 510, the medical record and/or the backup copy thereof are removed from locations indicated by their respective pointers. It is desirable, to remove these records only after storing the determined further copies of the medical record at block 508 to ensure that the proper number of backup copies are stored on the system at all times. It is possible, however, to remove copies and add the further copies in any order or, otherwise, simultaneously.

At block 512, file definition tables 264 and 239 corresponding to locations having the medical record and/or the backup copy thereof are updated with information regarding the removal of the of the medical record and/or the backup copy thereof. After processing for block 512 ends, operation proceeds to block 502.

According to certain embodiments of the present invention, network interface devices 250 at respective medical networks may translate the routing protocols internal to the respective medical network to a common routing protocol used externally between each network interface device and one or more archives 230.

According to certain exemplary embodiments, worklist manager 252 in conjunction with backup rule dictionary 262, respectively, may provide for identification and transfer of the medical records to be retrieved from network resources 180, 185 or 190. In other exemplary embodiments, the network resources 180, 185, and 190 may send the medical records to the network interface device 250.

In certain exemplary embodiments of the present invention, copies of the selected medical record may be distributed (cascaded) through a system to ensure that the selected medical records and copies thereof are properly stored at dispersed geographic locations according to backup and location rules of the system.

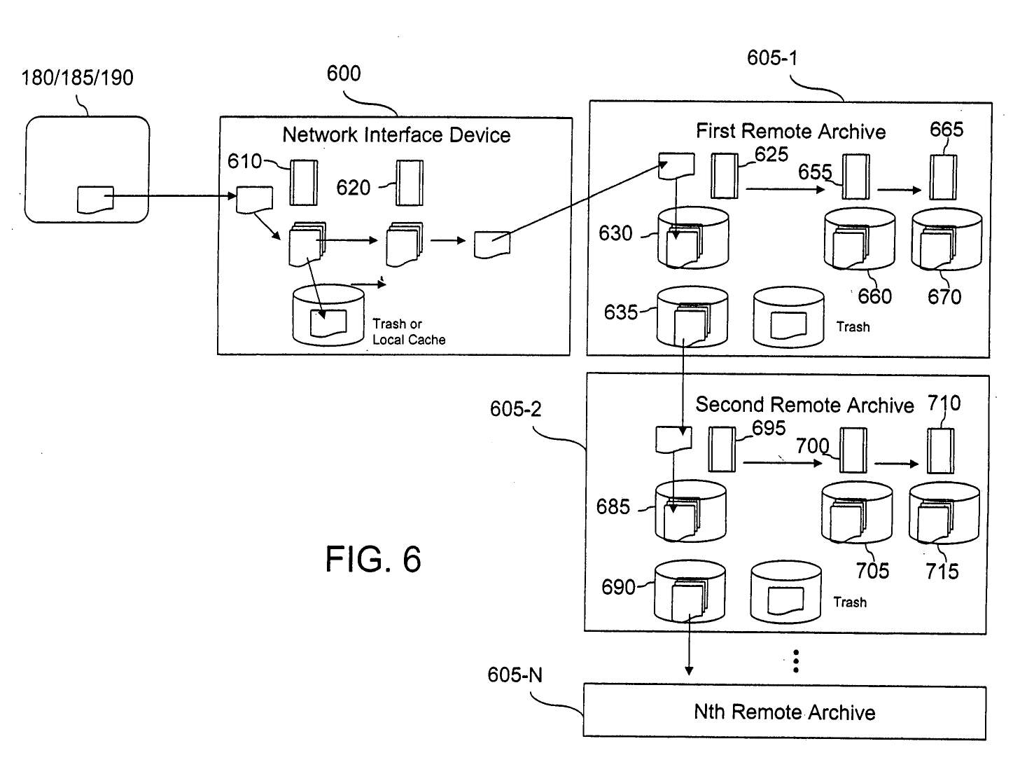

FIG. 6 is a schematic diagram illustrating a method of distributing backup copies of the a selected medical record in accordance with certain exemplary embodiments of the present invention.

Referring now to FIG. 6, a storage and retrieval system may include network interface device 600 and external (remote) archives 605-1, 605-2 . . . 605-N. As one example, network resources 180, 185 and 190 may provide medical reports in electronic format (e.g., a file) via a firewall (not shown) to network interface device 600. Network interface device 600 may include one or more computers (e.g., servers) 610 and 620 which process the medical reports. Server 610 may include a work queue area which accepts transmitted medical records generated from network resources 180, 185 and 190. This transmission may use a first transport protocol (e.g., a DICOM protocol, a HL7 protocol or other secured transmission protocol).

The medical record may be stored as a file in a first storage device on first server 610, a transaction of the reception of the medical record by the network interface device 600 may be logged and a pointer to the medical record may be stored in file definition table 264.

A copy of the medical record may be sent by first server 610 to a network staging area (NSA) of second server 620. The transmission of the copy of the medical record may use a second transport protocol. That is, the first sever 610 may provide protocol conversion from a first transport protocol used in the secured hospital network to a second transport protocol used in the remote archives 605-1, 605-2 . . . 605-N. The medical record may be stored, for example as a file, in a second storage device on second server 620, a transaction of the reception of the medical record may be logged by the second server 620 and a pointer to the medical record stored on the second server 620 may be stored in file definition table 264.

Responsive to the copy of the medical record being successful received by the NSA of second server 620, the medical record from the work queue area may be deleted or, otherwise, may be stored in a local cache of network interface device 600 depending on storage rules of network interface device 600.

The network staging area of network interface device 600 may transmit the medical record to a server 625 of a first remote archive (FRA) 605-1 based on backup and storage rules in backup rule dictionary 262 using the second transport protocol (which may include an XML wrapper). A transaction of the reception of the medical record by FRA 605-1 may be logged and a pointer to the received copy of the medical record may be stored in file definition table 239 at FRA 605-1.

Copies of the medical record received by FRA 605-1 may be sent and stored to first and second copy areas on storage devices 630 and 635, respectively. Storage devices 630 and 635 of FRA 605-1 store independent copies of the medical record such that further processing of these copies may be simultaneous. A first copy of the medical record may be sent from one of the first or second copy areas to another storage location (e.g., storage device 660 or 670 of servers 655 or 665, respectively) in FRA 605-1. A second copy of the medical record may be sent from the remaining one of the first or second copy areas to a second remote archive (SRA) which may cascade the electronic file in a similar manner to that of FRA 605-1 using server 695 and first and second storage devices 685 and 690. Further, the other storage locations in SRA 605-2 include storage devices 705 or 715 of servers 700 or 715, respectively.

Responsive to the first copy of the medical record being successful received (e.g., cyclic redundancy check (CRC) being validated) by the other storage location in FRA 605-1, the first copy of the medical record temporarily stored in one of the first or second copy areas 630 or 635 may be removed (e.g., deleted or moved). Responsive to the second copy of the medical record being successful received (e.g., the cyclic redundancy check being validated) by the SRA 605-2, the second copy of the medical record temporarily stored in the remaining one of the first or second copy areas 630 or 635 may be removed (e.g., deleted or moved). A notification to network interface device 600 regarding successful storage of the copies of the medical record may be sent from first and second remote archives 605-1 and 605-2. After notification of successful receipt of the copies by first and second remote archives 605-1 and 605-2, the selected medical record from the network staging area of network interface device 600 may either be removed (e.g., deleted) or, otherwise moved from network interface device 600 depending on storage rules of network interface device 600.

It is contemplated that additional copies of the selected medical record may be sent to further remote archives using a second copy of the selected medical record stored in a second location in the second remote archive 605-2 in a similar process to that of first remote archive 605-1, thus simplifying and paralleling the processes used in the system. Moreover, it would be recognized by one skilled in the art that a third independent copy or further independent copies may be stored in first remote archive 605-1 such that these copies are distributed (cascaded) to a third or further remote archives independently with notification back to the network staging area of network interface device 600. When more than one backup copy of the medical record is stored on the system, network interface device 600 may send out a notification to, for example the file location tables at the geographic locations where the copies are stored to update these tables with pointers to any backup copies of the selected medical record.

It is contemplated that the method for distributing (cascading) copies of the selected medical record through the system may be used for the initial backup of a record on the system or, otherwise when the selected medical record or any backup thereof is identified as being acted upon by the system (for example, when it is to be deleted from the system or moved to the secured network 160, among others.)

Although the cascading of the medical images is illustrated using network interface 600, it is contemplated that this method may be used with other system architectures such as peer-to peer architectures and other distributed architectures for distributing (cascading) copies of the selected medical record through a system.

Although the invention has been described in terms of linking of a selected medical record with its geographically dispersed copies, one of ordinary skill in the art recognizes that by establishing such a linkage, other system functionality may be incorporated into the system. For example, a user may: (1) delete all linked records from the system in one command; (2) consolidate a number of copies of the selected medical record into a smaller number of copies by removal of some or all of the copies; (3) the user may easily establish the number of copies of the selected image on the system; and (4) the user may change backup rules related to this medical record and move certain copies from one or more locations to one or more other locations according to the changed rules, either automatically or with user intervention.

Although the invention has been described in terms of a storage and retrieval system, it is contemplated that the invention may be implemented in software on microprocessors/general purpose computers (not shown). In this exemplary embodiment, one or more of the functions of the various components may be implemented in software that controls the general purpose computer. This software may be embodied in a computer readable carrier, for example, a magnetic or optical disk, a memory-card or an audio frequency, radio-frequency, or optical carrier wave.

Although the invention is illustrated and described herein with reference to specific exemplary embodiments, the invention is not intended to be limited to the details shown. Rather, various modifications may be made in the details within the scope and range of equivalents of the claims and without departing from the invention.

What is claimed:

1. A method of backing up medical records stored as electronic records in a system that includes a network interface device and a remote archive, the method comprising the steps of:
a) routing a selected medical record to the network interface device;
b) transferring one or more backup copies of the selected medical record to the remote archive;
c) linking the selected medical record and the backup copies thereof, each stored at locations geographically remote from each other; and
d) establishing one or more further backup copies of the selected medical record at one or more respective further backup locations, when at least one of the selected medical record or the backup copy thereof are to be removed from a respective one or ones of the geographically remote locations, each further backup location being remote from other further backup locations and from the geographically remote locations.

2. The method of claim 1, wherein step (b) of transferring the one or more backup copies of the selected medical record to the remote archive includes the steps of:
b-1) cascading one or more backup copies of the selected medical record in accordance with pre-established storage rules to one or more geographically dispersed storage locations.

3. The method of claim 1, wherein step (b) of transferring the one or more backup copies of the selected medical record to the remote archive includes the steps of:
b-1) storing one or more backup copies of the selected medical record in accordance with pre-established storage rules in one or more respective temporary storage devices in the remote archive;
b-2) notifying the network interface device that the one or more backup copies of the selected medical record are stored in the one or more respective temporary storage devices in the remote archive;
b-3) determining whether or not to remove the selected medical record from the network interface device in accordance with the pre-established storage rules, when the network interface device is notified in step (b-2) that the one or more backup copies of the selected medical record are stored in the one or more respective temporary storage devices in the remote archive; and
(b-4) removing the selected medical record from the network interface device in accordance with step (b-3).

4. The method of claim 3, wherein step (c) of linking the selected medical record and the backup copies thereof comprises the steps of:
transferring a first backup copy of the one or more backup copies of the selected medical record stored in a first temporary storage device of the one or more respective temporary storage devices to another storage device in the remote archive; and
updating pointers to the first backup copy in location tables at geographic locations where the selected medical record and each copy thereof are stored.

5. The method of claim 4, wherein step (c) of linking the selected medical record and the backup copies thereof comprises the steps of:
transferring a second backup copy of the one or more backup copies of the selected medical record stored in a second temporary storage device of the one or more respective temporary storage devices to a storage device in another remote archive; and
updating pointers to the second backup copy in location tables at geographic locations where the selected medical record and each copy thereof are stored.

6. The method of claim 5, wherein the transferring of the second backup copy of the selected medical record to a storage device in an other remote archive comprises the steps of:
transferring the second backup copy of the selected medical record stored in the second temporary storage device of the remote archive to a first temporary storage device in the other remote archive; and
transferring the second backup copy of the selected medical record stored in the first temporary storage device in the other remote archive to another storage device in the other remote archive.

7. The method of claim 1, wherein the selected medical records or each copy thereof is stored in a respective temporary storage device until notified that the selected medical records or each respective copy thereof has been successfully stored in a preset and corresponding storage device.

8. The method of claim 1, wherein step (c) of linking the selected medical record and the backup copy thereof includes the steps of:
c-1) determining a first location to store the selected medical record and a second location to store the backup copy of the selected medical record according to storage rules;
c-2) storing the selected medical record at the first location and a pointer to the selected medical record in a first table at the first location and the backup copy at the second location and pointers to the selected medical record and the backup copy thereof in a second table at the second location; and
c-3) updating the first table at the first location with information regarding the pointer to the backup copy of the selected medical record.

9. The method of claim 1, wherein step (d) of establishing the one or more further backup copies of the selected medical record at the one or more further backup locations, when at least one of the selected medical record or the backup copy thereof are to be removed from a respective one or ones of the first and second locations includes the steps of:
d-1) checking whether the selected medical record and/or the backup copy thereof are to be removed from one or ones of the first location and/or the second location;
d-2) if at least one of the selected medical record or the backup copy thereof are to be removed, creating the one or more further backup copies of the selected medical record at the one or more further locations according to the storage rules; and
d-3) linking the one or more further backup copies of the selected medical record with the selected medical record and the backup copy thereof.

10. The method of claim 9, further comprising the step of:
e) removing one or ones of the selected medical record and the backup copy thereof after the one or more further backup copies are established; and
f) removing links stored in the first, second and further tables indicating the pointers to the removed one or ones of the selected medical record and the backup copy thereof.

11. The method of claim 8, wherein step (d-3) of linking the further backup copy includes the steps of:
storing the one or more further backup copies of the selected medical record at the one or more further locations and pointers to the selected medical record, the backup copy and the one or more further backup copies in one or more further tables at the one or more further locations; and
updating the first and second tables at the first and second locations with information regarding the pointers to the one or more further backup copies of the selected medical record.

12. The method of claim 1, wherein the first location is data storage of the network interface device.

13. The method of claim 1, wherein the second location is data storage of a first remote archive external to and interfacing with the network interface device.

14. The method of claim 12, wherein the one or more further backup locations are further remote archives external to and interfacing with the network interface device via the first remote archive.

15. The method of claim 8, further comprising the step of:
storing pointers to the selected medical record, the backup copy thereof and any further copies of the selected medical record in one or more other tables located at other geographic locations.

16. The method of claim 8, further comprising the step of:
checking whether the selected medical record routed to the network interface device matches medical records stored in the system based on characteristics of the selected medical record and the medical records stored in the system.

17. The method of claim 16, wherein if the selected medical record matches a medical record stored in the system, further including the steps of:
determining whether additional copies of the medical record are to be stored on the system;
linking the additional copies that are to be stored on the system to the matched medical record; and
storing the additional copies that are to be stored at locations based on storage rules and a location corresponding to the matched medical record.

18. The method of claim 16, wherein if the selected medical record does not match any medical records stored in the system, further including the steps of:
assigning a unique identification to the selected medical record routed to the network interface device; and
storing with the pointer to the selected medical record in the first table the unique identification of the selected medical record and one or more predetermined characteristics of the selected medical record and with the pointers to the selected medical record and the backup thereof in the second table the unique identification of the selected medical record and one or more predetermined characteristics of the selected medical record.

19. The method of claim 18, wherein the one or more predetermined characteristics include at least two of: (i) patient ID; (ii) a modality; (iii) a modality station ID; (iv) a date of creation of the selected medical record; (v) a physician ID; (vi) a byte length of the selected medical record; (vii) patent name; (viii) patent birth date and/or (ix) one or more settings of the modality station.

20. The method of claim 1, wherein at least one of the selected medical record, the backup copy thereof or a respective further backup copy thereof is removed when the selected medical record, the backup copy or the respective further backup copy is deleted or moved from a storage location indicated by a corresponding pointer.

21. The method of claim 1, wherein the selected medical record includes at least one of: (i) a medical image; (ii) a physician report; (iii) a computer-generated medical report; (iv) patient information; or (v) a patent study.

22. The method of claim 1, wherein step (a) of routing the selected medical records uses a first communication protocol and the steps of linking and establishing uses at least a second communication protocol.

23. A method of copying medical records stored as electronic records in a system that includes geographically dispersed storage devices, the method comprising the steps of:
a) routing a selected medical record to and storing the selected medical record in a first storage device at one geographical location; and
b) automatically creating a copy of the selected medical record at another geographical location, different from the location of the selected medical record, when the selected medical record is removed from the system.

24. The method of claim 18, further comprising:
ensuring at least one of the selected medical record or the copy thereof is stored on the system by creating a subsequent copy of the selected medical record when a previously created copy thereof is removed from the system.

25. A system for backing up electronic medical records, comprising:
a network interface device located at a first geographic location for receiving a selected medical record, the network interface device including a first linking table; and
first and further remote archives include second and further linking tables, respectively, and are located at second and further locations which are different in geographic location from each other and from the first geographic location such that respective ones of the network interface device and the first and further remote archives store the selected medical record and a backup copy of the selected medical record, linking tables corresponding to the respective ones of the network interface device and the first and further remote achieves store pointers to the selected medical record and the backup copy of the selected medical record such that when at least one of the selected medical record or the backup copy thereof are to be removed from a respective one or ones of the first and second locations, one or more further backup copies are automatically stored in other ones of the network interface device and the first and further remote archives different than the respective ones of the network interface device and the first and further remote archives.

26. A computer readable medium for use with a computer for storing a program to execute the method of claim 1.
